(19) United States
(12) Patent Application Publication
(10) Pub. No.: US 2022/0122110 A1
(43) Pub. Date: Apr. 21, 2022

(54) AUTOMATIC STOCK PURCHASE OF COMPANIES OF PRODUCTS PURCHASED

(71) Applicant: David Godwin Frank, Redondo Beach, CA (US)

(72) Inventor: David Godwin Frank, Redondo Beach, CA (US)

(21) Appl. No.: 17/365,788

(22) Filed: Jul. 1, 2021

Related U.S. Application Data
(63) Continuation-in-part of application No. 17/140,956, filed on Jan. 4, 2021.
Application No. 17/140,956 is a continuation-in-part of application No. 17/075,442, filed on Oct. 20, 2020.

(51) Int. Cl. G06Q 30/02; G06Q 40/04; G06Q 40/02; G06Q 40/08; G06Q 20/20; G06Q 20/40; G06K 9/00

(52) U.S. Cl. CPC G06Q 30/0216; G06Q 40/04; G06Q 40/02; G06Q 40/08; G06Q 20/326; G06Q 20/40145; G06K 9/00906; G06K 9/00604; G06K 9/0012; G06Q 20/204

(57) ABSTRACT

An automated, dynamic digital financial management tool is described herein. The financial management tool enables a user to access all forms of payments, debt and transactions to be deducted automatically depending on which form of payment is chosen. The financial management tool documents every item/service purchased. The documentation enables a company/manufacturer/store to provide marketing and recall information to the user. The financial management tool is able to include any and/or all financial aspects of a user's life. The financial management tool is able to be implemented using a universal card. The financial management tool is able to include a pay station to receive payments. The financial management tool is able to include automated services. An automated, dynamic health management system is also described herein. The financial management tool enables automatic stock purchases based on product purchases.

### CROSS-REFERENCE TO RELATED APPLICATION(S)

This application is a continuation-in-part application of co-pending U.S. patent application Ser. No. 17/140,956, filed on Jan. 4, 2021, and titled “AUTOMATED, DYNAMIC DIGITAL FINANCIAL MANAGEMENT METHOD AND SYSTEM WITH RISK MANAGEMENT,” which is a continuation-in-part application of co-pending U.S. patent application Ser. No. 17/075,442, filed on Oct. 20, 2020, and titled “AUTOMATED, DYNAMIC DIGITAL FINANCIAL MANAGEMENT METHOD AND SYSTEM,” which are hereby incorporated by reference in their entireties for all purposes.

### FIELD OF THE INVENTION

The present invention relates to health management. More specifically, the present invention relates to health management using a single device.

### BACKGROUND OF THE INVENTION

Many people have multiple credit cards and/or debit cards for purchasing goods. These credit/debit cards have varying rewards and other benefits. Therefore, it is upon the user of the credit/debit cards to determine which card to use at which store. Additionally, having multiple credit/debit cards increases the chances of losing/misplacing one of the cards. Furthermore, many people are highly disorganized when it comes to their finances, particularly, when their expenses are distributed among multiple credit/debit cards and various bank/online accounts.

Many people use various applications (“apps”) and simply read food labels to monitor their nutritional information. However, the manual approach even with the assistance of apps is challenging, requires a significant amount of work, and usually only lasts for a short amount of time as the user tires of all of the effort. Moreover, manually tracking the information may not be accurate as it depends on the user's efforts.

### SUMMARY OF THE INVENTION

An automated, dynamic digital financial management tool is described herein. The financial management tool enables a user to access all forms of payments, debt and transactions to be deducted automatically depending on which form of payment is chosen. The financial management tool documents every item/service purchased. The documentation enables a company/manufacturer/store to provide marketing and recall information to the user. The financial management tool is able to include any and/or all financial aspects of a user's life. The financial management tool is able to be implemented using a universal card. The financial management tool is able to include a pay station to receive payments. The financial management tool is able to include automated services.

An automated, dynamic digital health management tool is described herein. The health management tool enables a user to access all forms of health/nutritional information to be analyzed automatically. The health management tool documents food items purchased. The health management tool is able to include any and/or all health aspects of a user's life. The health management tool is able to be implemented using a universal card. The health management tool is able to include automated services.

### BRIEF DESCRIPTION OF THE DRAWINGS

FIG. 1 illustrates a flowchart of a method of implementing a management system according to some embodiments.

FIG. 2 illustrates a flowchart of a method of utilizing a management system for payment according to some embodiments.

FIG. 3 illustrates a front view of a universal card according to some embodiments.

FIG. 4 illustrates a back view of a universal card according to some embodiments.

FIG. 5 illustrates a mobile device according to some embodiments.

FIG. 6 illustrates a diagram of a pay station according to some embodiments.

FIG. 7 illustrates a diagram of an autonomous delivery system implementing the management system according to some embodiments.

FIG. 8 illustrates a block diagram of an exemplary computing device configured to implement the management system according to some embodiments.

FIG. 9 illustrates a flowchart of a method of implementing a health management system according to some embodiments.

FIG. 10 illustrates a flowchart of a method of implementing a financial management system with physical currency according to some embodiments.

FIG. 11 illustrates a diagram of exemplary acquisition devices according to some embodiments.

FIG. 12 illustrates a flowchart of a method of implementing a financial management system with risk management according to some embodiments.

FIG. 13 illustrates a flowchart of a method of automatically purchasing stock based on purchases according to some embodiments.

FIG. 14 illustrates a diagram of a system for performing the automatic stock purchasing implementation according to some embodiments.

### DETAILED DESCRIPTION OF THE PREFERRED EMBODIMENT

An automated, dynamic digital financial management tool is described herein. The financial management tool enables a user to preload all forms of payments, debt and transactions to be deducted automatically depending on which form of payment is chosen. The financial management tool records/documents every item/service purchased. The documentation of the purchases includes recording the SKU code, the company/store, where the item/service was purchased, and/or other information. The documentation enables a company/manufacturer/store to provide marketing (e.g., coupons) and recall information to the user. The financial management tool is able to include any and/or all financial aspects of a user's life. The aspects are able to be classified such as lines of credit/payment, expenses, income, and so on. The financial management tool is able to be implemented using a universal card.

The universal card is able to store information for any number of lines of credit or other sources of funds. For example, a user has 3 credit cards and a debit card, and when a user uses the universal card, the universal card automatically determines the appropriate line of credit to use. Furthering the example, the 3 credit cards include a Target® credit card, a Visa® credit card, and a Discover® credit card, and when purchasing items at Target®, the Target® credit card information is automatically selected for payment since it provides the user a 5% discount on all items, but when at a gas station, the Visa® credit card provides double points, so that credit card information is automatically selected for payment. The method of automatic selections is able to be implemented in any manner such as user-specified and then automatically, computer-determined, or a combination thereof. For example, the universal card first determines which line of credit is usable at this location (e.g., if Store X does not accept Discover® cards, then that is removed from the options list). Furthering the example, a user is able to specify that they prefer cash discounts over credit card points, so the universal card is able to prioritize cash discounts over points. The universal card is able to intelligently compare 3× points versus 2× points versus 1× points, and select the line of credit which provides the highest amount/number of points. The universal card is able to store and/or access a set of rules or other algorithm which determines which payment source is utilized.

The universal card is able to compare the purchase price of the items/services with the amount of credit available, and if the purchase price exceeds the amount of credit available, then the universal card would not use that line of credit or is able to divide the purchase over multiple lines of credit.

Any combination of priorities, preferences, analysis, learning, selections, implementations and/or other factors are able to be analyzed, input, determined, stored and/or used.

In some embodiments, the universal card includes a processor, memory and programming to perform the analysis and make a decision, and in some embodiments, the universal card sends information to a system (e.g., server device, mobile device) to perform the analysis and make a decision.

In some embodiments, the universal card is usable similar to credit cards with a magnetic strip to be swiped, a microchip to be inserted into a microchip reader, and/or the microchip to be detected/read based on a tap by a microchip reader. In some embodiments, a digital version of the universal card is stored on a mobile device (e.g., smart phone, smart watch), so that the user does not need to carry a physical card. In some embodiments, the universal card is used in conjunction with Apple Pay, Google Pay, and/or similar digital payment systems.

In some embodiments, a physical pay station is implemented to utilize the universal card and/or another user recognition system. For example, the pay station includes a retina scanner, a fingerprint scanner and/or other biometric scanner to determine who the user is, and then trigger the automatic payment based on the lines of credit associated with the particular user. In some embodiments, the pay station includes a pulse detection implementation to provide against specific types of fingerprint theft or other theft.

As mentioned, the management tool is able to include many sources for payment such as credit cards, debit cards, house lines of credit, business lines of credit, checking accounts, savings accounts, digital payment accounts (e.g., PayPal), digital business accounts (e.g., Amazon/Synchrony bank), bitcoin accounts, gift cards, stock trading accounts, retirement accounts, social security accounts, government assistance accounts, and/or any other financial sources.

In some embodiments, the management tool is configured to communicate among the many payment sources to exchange payments that otherwise would not be exchangeable. For example, if a user has a Starbucks® gift card, the user is able to input that gift card into the management tool, and the management tool is able to perform a background transaction where the gift card is usable at a non-Starbucks location. Behind the scenes, the financial organizations are able to perform the transactions such that each location is made whole. In an example, using a peer-to-peer system, when another user purchases an item from Starbucks®, the gift card of the current user is applied to that purchase, and the monetary transaction from the other user is transferred in a manner that the current user is able to purchase from the non-Starbucks location.

The management tool is able to record and store many sources of expenses/debts such as by tracking all of the purchases a user makes at physical locations and digital locations. The details of the purchases are able to be as specific or as general as desired or needed. For example, a supermarket purchase is able to include which items were purchased, the date of the purchase, the expiration dates of the items purchased, how frequently the items are purchased (e.g., based on historical purchase information), trends of purchases, how the items were purchased, the location of the purchase, and so on. Other expenses/debts are able to be recorded by the management tool such as a house mortgage, car loan, business loan, other loans, child support, spousal support, utilities, activities, health insurance, and other debts.

The management tool is able to record and store many sources of income such as occupational income, rental income, stock/bond income, and others.

Based on all of the financial information available to the management tool, the management tool is able to assist a user in paying for items, purchasing items, determining which items to purchase or not, and providing additional information. For example, a user's debt-to-income ratio is able to be calculated and used to assist in making purchases such as purchasing a house, and guiding the user to a house that is within the user's budget.

The management tool is able to be used to prevent financial crime. For example, if an anomalous purchase is detected, additional verification is able to be requested, an alert is able to be triggered, and/or the purchase is able to be blocked. For example, if a purchase is detected in a country where the user is not located, then an alert is able to be sent to the user's phone, where the user is required to input a code to verify that he is the user attempting to make the purchase.

Based on the financial information of a user, targeted marketing is able to be implemented. Not only is the marketing based on a user's purchases, which will be known using the management tool, but the marketing is able to be based on the user's current financial situation, which enables more effective targeting. For example, a user with a low debt-to-income ratio is able to be marketed more expensive items, whereas a user with a high debt-to-income ratio is marketed less expensive items.

The management tool is able to be used for tax planning purposes to be documented into a Schedule C on a 1040 form. For example, if the management tool is used for a business, and the user (business owner) purchases items for the business, the purchase is an expense for that business. At the end of the year, the management tool is able to provide a detailed accounting of the income and expenses throughout the year.

The management tool is able to perform currency exchanges. For example, if the user travels to another country, the management tool is able to pay in the currency of the current country, regardless of the user's country of origin.

The management tool is able to be used to as a money exchange (e.g., person to person, person to business, or business to business).

All of the information is gathered automatically by the management tool such that the user does not need to manually enter information. The management tool is able to perform all of the transactions described herein in real-time.

In some embodiments, a user subscribes to gain access to the management tool.

A management company providing the management tool is able to receive a subscription payment (e.g., monthly, yearly, one-time). The management company is also able to receive a percentage of a purchase (e.g., 3% of the purchase price goes to the management company). The management company is also able to receive referral fees or marketing fees based on the directed marketing to the subscribers.

In some embodiments, the management tool analyzes and detects patterns of purchases by a user, and automatically suggests or makes purchases based on the detected patterns. For example, the management tool determines after a month of analysis, that a user purchases a gallon of milk every Sunday from Store X, so the management tool provides offers to have milk delivered once a week, or enables milk to be available in a pre-paid pickup from Store X every Sunday.

FIG. 1 illustrates a flowchart of a method of implementing a management system according to some embodiments. In the step 100, the management system is configured for a user. Configuring the management system is able to be performed manually, automatically or semi-automatically. Configuring is able to include a user subscribing to the management system. Subscribing is able to be performed similarly to other subscriptions such as inputting personal information and/or retrieving personal information (e.g., from a social networking site). After subscribing, the user's financial information is acquired. The user is able to manually input information such as credit card information, bank account information, and/or any other financial information. In a semi-automatic implementation, the user is able to manually enter some financial information, and the system (e.g., server) is able to acquire additional financial information of the user. In another example, the user provides his social security number, and the system retrieves banking information associated with the user, but the user inputs gift card information and other information not found by the automated search. In an automatic implementation, the system automatically retrieves the user's financial information. For example, based on facial recognition (or other biometric recognition), the system determines who the user is, and then accesses financial information for that user by communicating with banks, credit card companies, and other financial companies.

Configuring the management system is able to include providing personal preferences and/or automatically determining which line of credit is used to pay for which goods/services. For example, a user is able to specify which line of credit is utilized by the management system when purchasing items at which location. Similarly, the management system is able to automatically determine which line of credit is utilized at which location. Since the management system is able to include many sources of credit/payment, the management system is able to prioritize the sources of credit/payment. For example, if the management system is managing gift cards for the user, those gift cards may be used up first since they may have an expiration date. In another example, lines of credit which provide the highest discount or rewards are utilized. An exemplary priority list includes:
1. Gift cards
2. Lines of credit with a purchase discount
3. Lines of credit with a monetary reward
4. Lines of credit with the highest point reward
5. Checking account (default)

In another example, a table or other data structure is utilized to determine which credit/payment source is used for which purchase/store. An exemplary table is shown:

| Store | Credit/Payment Source |
|---|---|
| Target | Target card |
| Macy's | Visa card |
| Old Navy | Visa card |
| Lucky | Mastercard card |

By matching up the store with the credit/payment source preemptively, the process of determining the appropriate card to use is more efficient, and a determination is not necessary while a purchase is being made. In some embodiments, to further optimize the process, after determining the credit/payment sources for a user, the stores within a specified area (e.g., 20 mile radius) are analyzed and added to the data structure with the corresponding selected credit/payment source. In some embodiments, using GPS or other geolocation implementation, the system is able to detect that a user is near a certain location (e.g., business), and is able to preemptively determine the most beneficial credit/payment source for that location. For example, if the user travels and based on GPS, it is determined that the user is visiting Store X, the system is able to perform the analysis to determine the credit card with the best perks for Store X, and saves the information in the data structure, so that when the user purchases items, the appropriate credit/payment source is already determined.

In the step 102, the management system is utilized. Utilizing the management system is able to include many different features such as making a payment, automatically making additional purchases, providing targeted marketing, and any other features discussed herein. As mentioned in terms of configuring the management system, when a user makes a purchase, the management system determines where the payment is coming from. Based on preferences/priorities, the most financially beneficial source of credit/payment is selected. For example, when a user goes to a store and uses that store's line of credit, they may be given a discount on the purchase, so it would be most beneficial to use that store line of credit. The management system is able to include sets of rules (e.g., in a database/table format) which determine which line of credit to use. The rules/criteria are able to be organized and implemented in any manner such as specific and general rules. For example, the rules are able to specify: use line of credit A for Stores X, Y, Z and line of credit B for Stores J, K, L. In another example, the rules are able to specify: use line of credit A for stores in the grocery category, and line of credit B for gas stations and sporting goods stores. If a purchase does not fall in a category, a default line of credit/payment is able to be used. In some embodiments, the system uses a learning algorithm to determine which line of credit to use for each store. The rules/criteria are able to be stored/implemented on a server device, a user device (e.g., smart phone), in a universal card, another device, and/or a combination thereof.

Since the management system monitors/tracks the purchases by the user, the management system is able to determine patterns of purchases and make projections for future purchases, and make those future purchases at the appropriate times. In some embodiments, the automated purchasing is able to be utilized with an automated store and an automated delivery service to have the purchased items delivered to a user.

The management system is also able to enable/perform targeted advertising based on the user's purchases and other monitored information. As described, targeted advertising is able to include monitoring and analyzing the user's purchases, as well as monitoring and analyzing other financial information of the user. For example, the system monitors and tracks all of the individual items purchased by the user including any additional helpful information such as when purchased, how often purchased, purchased at which store, coupon used, are there any complementary items purchased/to be purchased (e.g., hamburger patties and buns), SKU number, expiration date, and/or any other information. The system is also able to monitor and analyze the user's income, other family member income, expenses, bank account information and other financial information which may be used to provide an advertisement that specifically targets the user. The targeted advertisement is able to be appropriately timed (e.g., when the previously purchased product is about to expire), based on the financial status of the user, to provide a complement to a previously purchased item, based on a special event (e.g., birthday, anniversary, child's birth) and/or any other relevant information. The targeted advertising is able to be based on any characteristic of the user such as sex/gender, age, marital/relationship status, and/or any other characteristics. The targeted advertising is able to be presented to the user in any manner such as a mobile device (or any device) associated with the subscription (e.g., via corresponding login information or social networking information).

The management tool is able to be used to digitalize and store all transactions on receipts of a consumer/user. Any aspect of a transaction of a user, consumer, business, and/or other entity is able to be stored using the management tool. Aspects of the transaction include the goods/services purchased, the time/date of the purchase, the costs involved (e.g., price paid by consumer, and retail cost, wholesale cost, profit for business).

The management tool enables users to sell/buy products/services, including making recommendations of products/services to buy/sell. The user-to-user transactions are able to be stored for the buyer and seller. The recommendations are able to be based on previously purchased items. For example, if a consumer purchases an item that uses replaceable items (e.g., a coffee maker), then recommendations/advertisements or other targeted messaging is able to be provided to the consumer by the management tool (or another service which accesses data acquired by the management tool). The recommendations are able to be based on any information/characteristics (e.g., age/gender) similar to the targeted advertising. In some embodiments, the management tool implements a social networking aspect to connect users with items that are recommended to sell and to purchase. For example, if User A has an item that he would like to sell or has been recommended to sell by the management tool, and User B would like to purchase that item or has been recommended to purchase that item, then the management tool is able to connect User A and User B. In some embodiments, the management tool connects the users regardless of their previous relationship (e.g., possibly not related), and in some embodiments, the management tool only connects the users if they have a pre-existing relationship (e.g., are in each other's social network, have friended each other).

In some embodiments, fewer or additional steps are implemented. In some embodiments, the order of the steps is modified.

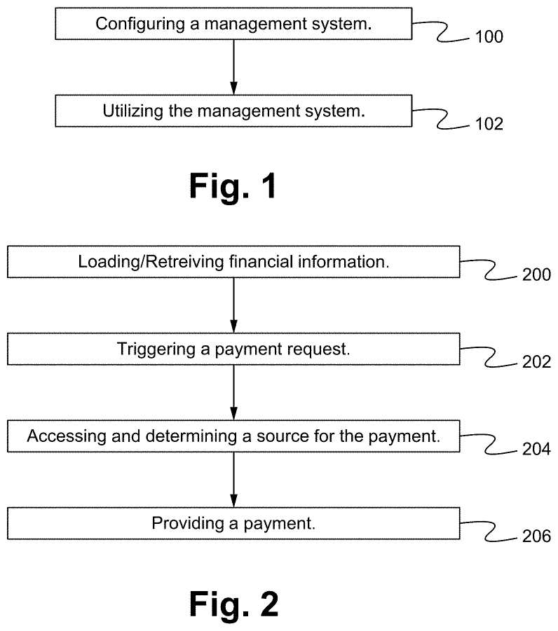

FIG. 2 illustrates a flowchart of a method of utilizing a management system for payment according to some embodiments. In the step 200, financial information is loaded/retrieved. As described herein, the financial information is able to be retrieved in any manner such as being manually input by a user, and/or retrieved automatically using the management system from financial institutions. In some embodiments, retrieving the financial information includes many types of financial information as described herein such as income, credit, expenses, gift cards and more. The financial information is retrieved by and stored on a device such as a universal card, a user device (e.g., smart phone) and/or a server.

In the step 202, a payment request is triggered. The payment request is able to be triggered in any manner such as at a grocery store, where a user is requested to pay for his groceries. The payment request is able to be triggered by a standard payment processing device (e.g., a credit card reader), an online payment app, a pay station, and/or any other device. For example, the payment request includes: pay $53.25 to Store X. Additional information is able to be included in the payment request such as specific items, the date, the address of the store, and/or other information, in some embodiments. After a payment request is triggered by a payment processing device (or other device), the payment request to payment source is able to be triggered by a device such as a universal card, a user device (e.g., smart phone) and/or a server.

In the step 204, a source for the payment is determined and accessed. Upon receiving the payment request which is able to include specific information such as the location of the request, the management system determines which source for the payment to be used. As described herein, the management system is able to include a database or data structure for determining which payment source to be used for each purchase location. Determining and accessing the payment source is able to be from a device such as a universal card, a user device (e.g., smart phone) and/or a server.

In the step 206, the payment is made using the determined payment source. For example, the selected credit card information is utilized to pay the store, and the transaction is completed. The payment occurs by accessing (via a device) the payment source and receiving payment information from that source. In some embodiments, the order of the steps is modified. In some embodiments, fewer or additional steps are implemented.

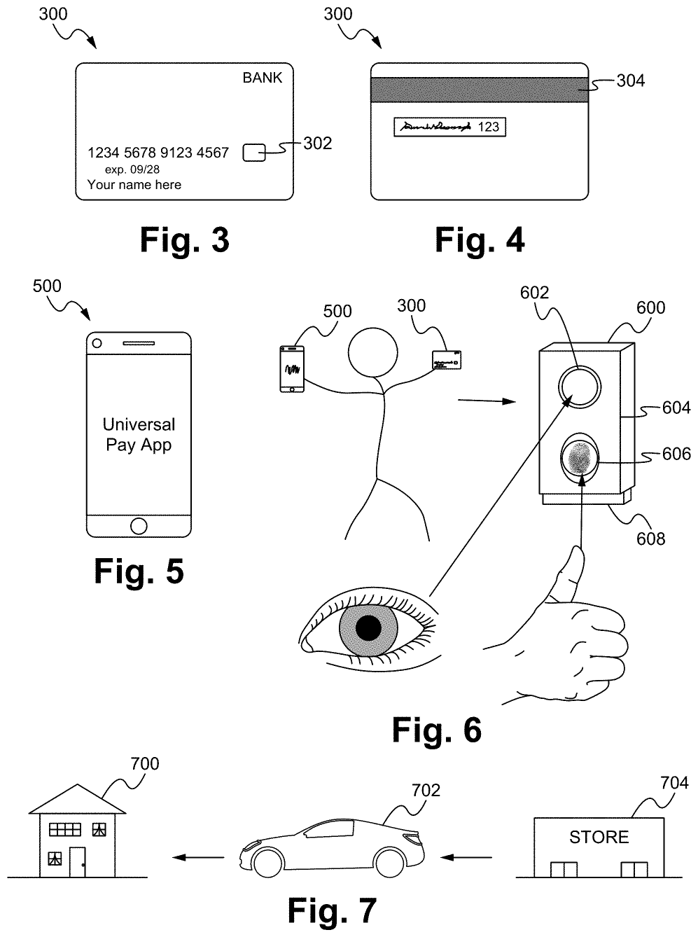

FIG. 3 illustrates a front view of a universal card according to some embodiments. The universal card 300 is able to be shaped similar to a credit card so that it is usable in standard credit card readers. The universal card 300 is able to include a microchip 302 which is able to be programmed to perform the management system tasks and/or communicate with a server device or another device to perform the management system tasks.

FIG. 4 illustrates a back view of a universal card according to some embodiments. The universal card 300 is also able to have a magnetic strip 304 similar to credit cards. The magnetic strip 304 is able to be swiped, and then based on the swipe, a server device or another device is able to be triggered that a payment is to be made. The server device or other device then determines from which payment source the payment should come from, and generates the payment information.

FIG. 5 illustrates a mobile device according to some embodiments. The mobile device 500 is able to be any mobile device such as a smart phone, a smart watch, and an autonomous vehicle. The mobile device 500 is able to be configured to implement the management system described herein. When a payment request is received, the management system on the mobile device 500 is able to perform the steps of providing a payment from a payment source based on the criteria/rules of the management system. The mobile device 500 is able to be used similar to Apple Pay or Google Pay in terms of receiving a payment request from a store's pay station which accepts digital payment. Unlike the previous payment systems, the management system is able to store/access many payment sources and provide the payment source that is most beneficial to the user. The management system is also able to be implemented on other devices as well (e.g., personal computer).

FIG. 6 illustrates a diagram of a pay station according to some embodiments. The pay station 600 is able to include a retina scanner 602, a magnetic strip reader 604, a fingerprint 606 scanner, a chip reader 608 and/or any other device for payment receipt and/or security. The pay station 600 is able to include a processor, memory and programming to perform digital payments (e.g., Apple Pay) from a mobile device 500 and/or perform other functions. The pay station 600 is able to receive the universal card 300 using the magnetic strip reader 604, the chip reader 608 and/or the digital payment programming. The retina scanner 602 and/or the fingerprint scanner 608 are able to be used for user verification.

In some embodiments, the retina scanner 602 and/or the fingerprint scanner 608 are able to include a pulse detection mechanism to prevent fraud. Pulse detection or other determinations that a fake finger is not being used is able to include laser triangulation and utilizing light within the fingerprint detection device to measure internal bodily features of the finger such as blood movement. For example, the fingerprint scanner uses a laser to detect movement of internal structures (e.g., veins) by triggering a laser, then detecting reflections of the laser including an amount of time for the reflections to be received, measuring a delta in reflection time, and if there is a change (e.g., above a threshold), then the change is due to movement of internal structures such as due to blood flow, which indicates that the user is alive. A similar system is able to be included in the retina scanner.

In some embodiments, the management system is able to be used with the fingerprint scanner 608 and/or retina scanner 602 without the universal card 300. For example, a user places his finger in the fingerprint scanner 608 which is able to identify the user, and then based on the user identification, determine that the user has access to the management system which then automatically selects the appropriate payment source. Any other security measures are able to be utilized to prevent misuse and theft of a user's identity.

FIG. 7 illustrates a diagram of an autonomous delivery system implementing the management system according to some embodiments. Based on a user's purchase history which is able to be recorded and analyzed by the management system, the management system is able to utilize an autonomous delivery system for future purchases. Using an autonomous delivery system, items at a store 704 are able to be gathered and transported using a vehicle 702 to the user's house 700. The store 704 is able to be the store that the user has previously shopped at or a comparable store as determined by the management system and/or the user. In some embodiments, the management system does price comparisons of stores to help determine the best prices for comparable items. The store 704 is able to be an automated store where devices/systems are able to gather items for delivery. The store 704 is able to be a non-automated store where a human gathers the items for delivery. Once the items are gathered, the items are transported using a vehicle 702. The vehicle 702 is able to be any vehicle such as an autonomous car/truck, a drone (autonomous or not), a non-autonomous car/truck with a driver and others. The vehicle 702 is used to deliver the items at the user's house 700 or another destination.

In an example of a fully automated system, an autonomous store 704 utilizes machinery such as robots and conveyor belts to move items into a transport device (e.g., a box). The gathered items are then placed in or are retrieved by a vehicle 702 (e.g., autonomous drone) which is able to utilize mapping information and GPS to transport the items to the user's house 700. In some implementations, the vehicle 702 leaves the items at the user's doorstep or another location. In some implementations, the vehicle 702 (e.g., drone) is able to enter the house automatically (e.g., via a digital doorlock which is accessible by the automated vehicle, and place the items in the refrigerator and/or other locations inside the house. Upon completing the delivery, the vehicle 702 is able to leave the house, lock the digital lock, and return to the store 704 or another location.

Any aspects of a delivery system using the management system are able to be performed manually or autonomously.

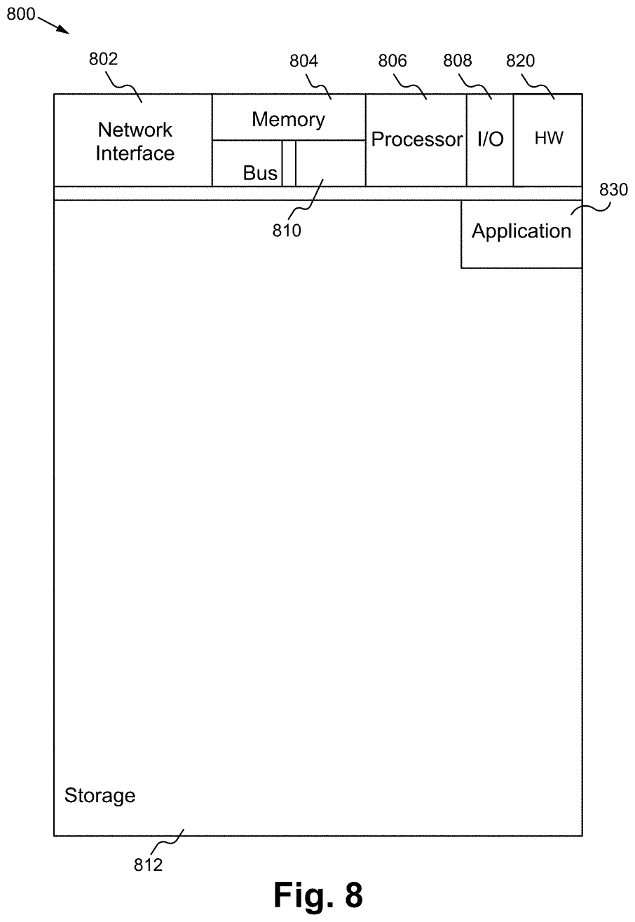

FIG. 8 illustrates a block diagram of an exemplary computing device configured to implement the management system according to some embodiments. The computing device 800 is able to be used to acquire, store, compute, process, communicate and/or display information. The computing device 800 is able to implement any of the management system aspects. In general, a hardware structure suitable for implementing the computing device 800 includes a network interface 802, a memory 804, a processor 806, I/O device(s) 808, a bus 810 and a storage device 812. The choice of processor is not critical as long as a suitable processor with sufficient speed is chosen. The memory 804 is able to be any conventional computer memory known in the art. The storage device 812 is able to include a hard drive, CDROM, CDRW, DVD, DVDRW, High Definition disc/drive, ultra-HD drive, flash memory card or any other storage device. The computing device 800 is able to include one or more network interfaces 802. An example of a network interface includes a network card connected to an Ethernet or other type of LAN. The I/O device(s) 808 are able to include one or more of the following: keyboard, mouse, monitor, screen, printer, modem, touchscreen, button interface and other devices. Management system application(s) 830 used to implement the management system method are likely to be stored in the storage device 812 and memory 804 and processed as applications are typically processed. More or fewer components shown in FIG. 8 are able to be included in the computing device 800. In some embodiments, management system hardware 820 is included. Although the computing device 800 in FIG. 8 includes applications 830 and hardware 820 for the management system, the management system is able to be implemented on a computing device in hardware, firmware, software or any combination thereof. For example, in some embodiments, the management system applications 830 are programmed in a memory and executed using a processor. In another example, in some embodiments, the management system hardware 820 is programmed hardware logic including gates specifically designed to implement the management system.

In some embodiments, the management system application(s) 830 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle), a universal card, a pay station, or any other suitable computing device.

The computing device is able to implement any of the health management aspects described herein.

An automated, dynamic digital health management tool is described herein. The health management tool records/documents every food item and/or other health-related products/services (e.g., treadmill/gym membership) purchased. The recordation/documentation of the purchases includes downloading/recording nutritional information, the SKU code, brand/product information, the company/store, where the item/service was purchased, and/or other information. The nutritional information is able to include any nutritional information such as calories, fat, sodium, protein, vitamins, minerals, and/or any other information. The documentation enables a company/manufacturer/store to provide marketing (e.g., coupons) and recall information to the user. The health management tool is able to be used to provide information for a user regarding what and when to eat. The health management tool provides guidance of where to purchase certain items such as gluten-free items, organic items, or any other item. Providing the guidance is able to be a monetization aspect.

A universal card is able to store information including financial information to purchase items, but also health/nutritional information.

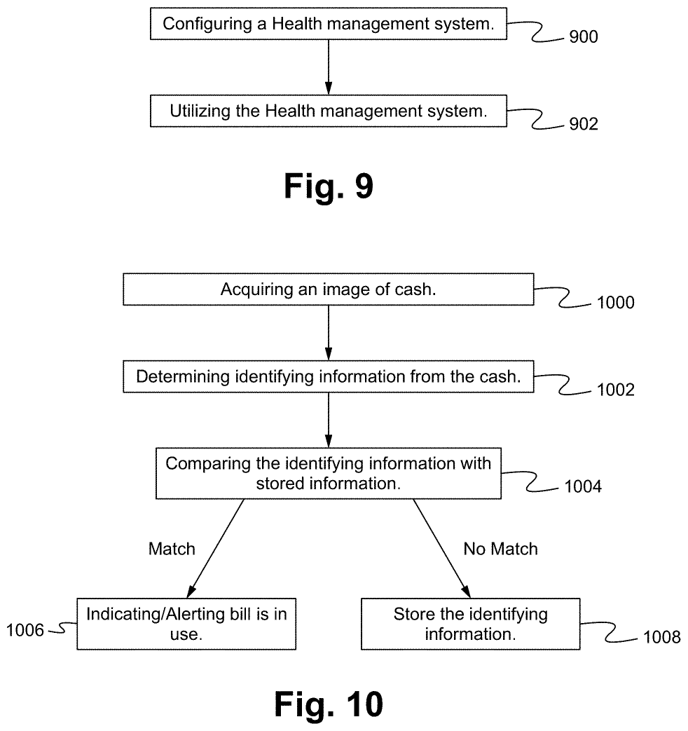

FIG. 9 illustrates a flowchart of a method of implementing a health management system according to some embodiments. In the step 900, the health management system is configured for a user. Configuring the health management system is able to be performed manually, automatically or semi-automatically. Configuring is able to include a user subscribing to the health management system. Subscribing is able to be performed similarly to other subscriptions such as inputting personal information and/or retrieving personal information (e.g., from a social networking site). After subscribing, the user's health and/or financial information is acquired. The user is able to manually input information such as height, weight, age, current medical conditions, allergies/sensitivities, desired/goal weight, fitness goals, and/or any other health information. The user is also able to manually input information such as credit card information, bank account information, and/or any other financial information. In a semi-automatic implementation, the user is able to manually enter some health and/or financial information, and the system (e.g., server) is able to acquire additional health and/or financial information of the user. In another example, the user provides his social security number, and the system retrieves medical and/or banking information associated with the user (e.g., from online health records from a doctor's office and/or banking records), but the user inputs other information not found by the automated search. In an automatic implementation, the system automatically retrieves the user's health and/or financial information. For example, based on facial recognition (or other biometric recognition), the system determines who the user is, and then accesses health and/or financial information for that user by communicating with hospital/doctor's offices, banks, credit card companies, and other medical/financial companies.

Configuring the health management system is able to include providing personal preferences and goals. For example, users are able to provide food preferences, grocery store preferences, exercise routines, weight goals, health goals, and/or any other preferences/goals. Users are also able to indicate which activities they enjoy and/or any equipment (e.g., exercise equipment, running apparel, smart watch/fitness band) which are able to be used with the health management system.

In the step 902, the health management system is utilized. Utilizing the health management system is able to include many different features such as acquiring nutritional information when a purchase is made. For example, the health management system acquires detailed information about a purchase including a SKU number or other identifying information, and the health management system is able to use that information to look up and download nutritional information. The health management system is also able to make suggestions to a user of what to purchase.

The health management system is able to make a suggestion at any time. For example, as the user is shopping, the health management system is able to indicate whether an item is a healthy pick or should be avoided based on the nutritional information (e.g., user scans an item's barcode to receive nutritional information). Determining whether the item is a healthy pick is able to be based on the nutritional facts, a user's health goal (e.g., lose 10 pounds), the user's medical history (e.g., food allergies/sensitivities) and/or any other factors. The suggestions are able to be based on financial management system information as well. For example, the suggestions are able to be based on a user's budget. Furthering the example, if the user has a budget of $100 per month for groceries, the health management system will suggest more inexpensive items compared to a user with a $1,000 budget. The suggestions are able to be based on more analysis such as determining which day of the month it is, analyzing shopping histories, factoring how much of the user's food budget is left, a determined or user-input preference of quantity versus quality, health/fitness goals, medical history and/or any other factors. For example, the user's current bank account is at $1,250, and if the user has indicated that he does not want his bank account to drop below $1,000, and there are no other expected expenses before the user's next paycheck at the beginning of the next month, the health management system is able to provide suggestions that keep the spending below $250. The suggestions are able to be each time an item is selected (e.g., scanned by a user's phone) or an entire purchase budget. For example, the health management system is able to provide a user a shopping list that factors in the user's budget, the user's health information, and the food nutritional information.

As the user is checking out at a grocery store, the health management system is able to indicate whether an item is acceptable for the user. For example, if the user is trying to lose weight, any items that have too many calories per serving are rejected for purchase. A warning is able to be provided to a user indicating that the item does not fit certain criteria or another action is able to be taken. In some embodiments, a smart pay station is able to access a user's health information and/or financial information to determine suggestions and/or allowable food items. In some embodiments, a user's mobile device and/or a server device are utilized to determine suggested and/or allowable food items.

As the user is shopping online, suggestions are able to be provided. The user's app or browser is able to highlight different items based on the user's health information and/or the items' nutritional information. For example, if the user is on a gluten-free diet, any items that contain gluten are grayed out, are not displayed, and/or another highlighting feature is implemented. Suggestions are able to be provided to the user (e.g., using pop-ups or a suggested page), where the suggestions are based on various health and/or financial information.

For autonomous shopping, the health management system is able to analyze the user's history of purchase and health information to automatically purchase or place items in a virtual shopping cart for purchase. For example, the health management system has received a doctor's diagnosis of diabetes, so items that have previously been purchased autonomously such as milk and vegetables are still able to be purchased, but based on the new health information, other previously purchased items such as cookies may be eliminated from the autonomous purchase. Additionally, to optimize savings and nutritional purchases, autonomous shopping is able to occur from multiple stores, where the health management system comparative shops among the stores within a specified area, and is able to make multiple purchases to be picked up or delivered to the user.

The health management system is able to provide a user with suggestions on when and what to eat. For example, if the user has a medical issue related to heartburn, doctors recommend avoiding eating within 3 hours of sleeping, so the health management system suggests the user eat at 6 pm to be finished with dinner before 7 pm, if the user's bed time is 10 μm. There are also dietary changes recommended for heartburn such as avoiding alcohol, spicy foods, acidic foods, and carbonated beverages, so when a user is shopping, the health management system suggests the user to buy water and mild foods and to avoid beer, soda and orange juice. In some embodiments, health management system displays a color-coded shopping list of food, where food items to avoid are grayed out, in red (or a red background) or are not even listed. In some embodiments, additional color-coding is used such as orange to indicate acceptable but not great options, and green to indicate the most appropriate options.

Similarly, to lose weight, the health management system is able to provide a detailed meal plan of what to eat and when to eat it. The meal plan is able to include total calories, fat, sugars, and any other information that may be helpful in a user achieving her goals. The meal plan is able to be part of a health plan which also includes details on when and how to exercise.

The health management system is also able to enable/perform targeted advertising based on the user's health information, purchases, financial information and/or other monitored information. As described, targeted advertising is able to include monitoring and analyzing the user's purchases, as well as monitoring and analyzing other financial information of the user. For example, the system monitors and tracks all of the individual items purchased by the user including any additional helpful information such as when purchased, how often purchased, purchased at which store, coupon used, are there any complementary items purchased/to be purchased (e.g., hamburger patties and buns), SKU number, expiration date, and/or any other information. The system is able to monitor the user's health information. The system is also able to monitor and analyze the user's income, other family member income, expenses, bank account information and other financial information which may be used to provide an advertisement that specifically targets the user. The targeted advertisement is able to be appropriately timed (e.g., when the previously purchased product is about to expire), based on the financial status of the user, based on the health status of the user, to provide a complement to a previously purchased item, based on a special event (e.g., birthday, anniversary, child's birth) and/or any other relevant information. The targeted advertising is able to be based on any characteristic of the user such as sex/gender, age, marital/relationship status, and/or any other characteristics. The targeted advertising is able to be presented to the user in any manner such as a mobile device (or any device) associated with the subscription (e.g., via corresponding login information or social networking information).

The health management system enables users to sell/buy products/services, including making suggestions of products/services to buy/sell. For example, if a user is trying to improve her stamina, the health management system is able to recommend exercise equipment such as a treadmill. Since the health management tool includes or is able to be used in conjunction with the financial management tool, the suggestion is able to be tailored specifically to the user based on the user's financial status. For example, a college student trying to get into better shape based on analyzed health information, receives a suggestion to purchase a low-end treadmill and/or some exercise weights, as opposed to a wealthy businessperson who receives a suggestion to purchase a high-end treadmill and/or a full set of home gym equipment. By taking into account a user's financial situation and/or other information such as living arrangements (e.g., dorm versus large house), as well as their health information, more accurate and helpful suggestions are able to be provided. In conjunction or as a follow up to the suggestion of fitness equipment, additional suggestions are able to be provided (e.g., running shoes). Again, the suggestion would be tailored based on specific user details and more generic information such as overall ratings and/or reviews from reviewers/consumers. By providing a mixed tailored suggestion, each user is able to receive the best option based on their budget and for their specific health situation.

In some embodiments, fewer or additional steps are implemented. In some embodiments, the order of the steps is modified.

Companies are able to utilize health information to provide guidance/suggestions of where to purchase items. For example, if a user is specifically looking for an allergen-free item (e.g., gluten-free, soy free, dairy free) or organic foods, companies are able to send information to the user. For example, online companies are able to provide an advertisement (e.g., within an app or on a web page), a communication (e.g., text message, email, Facebook posting), a coupon, and/or any other information to guide the user to their store and/or their products. The companies are able to provide tiered advertisements/information, so that the appropriate advertisement reaches the user. For example, a supermarket generates an advertisement for a lower priced organic food to be provided to those looking for organic foods but have less money in their bank accounts, and the supermarket generates a different advertisement for a higher priced organic food to be provided to those looking for organic foods and have bank accounts above a money threshold. In some embodiments, the companies do not have access to the financial management information and/or health management information, so the companies merely provide the different advertisements/information, and the health/financial management system provides the appropriate advertisement/information to the appropriate user based on their specific health/financial information/status. The health/financial management system is able to receive a payment from the companies for providing the targeted advertisements/information.

In some embodiments, the physical pay station described herein is able to acquire health information from the user in addition to or instead of the biometric scanning. For example, the pay station is configured to check oxygen levels, blood pressure and/or any other health information of the user. The health information is able to be stored and used by the health management system.

In some embodiments, the financial management system is configured to manage cash (e.g., dollar bills and coins or their equivalents). A user/business is able to take a picture of money (e.g., pictures of each side of a dollar bill). A physical pay station (and/or an enhanced scanner) is configured to scan/acquire images of money. Once the cash is scanned/photographed, the money is deposited into a user's bank account or another account (e.g., a business's account). The deposited cash is able to be accessed using the universal card (e.g., a user deposits the cash by taking a photograph and then uses his universal card which accesses the deposited cash to purchase items). The physical currency is no longer usable until it is re-authorized by a bank In some embodiments, the user is required to physically provide the physical currency to a bank or other designated business within a specified amount of time (e.g., 7 days); otherwise, the deposit is rejected/withdrawn.

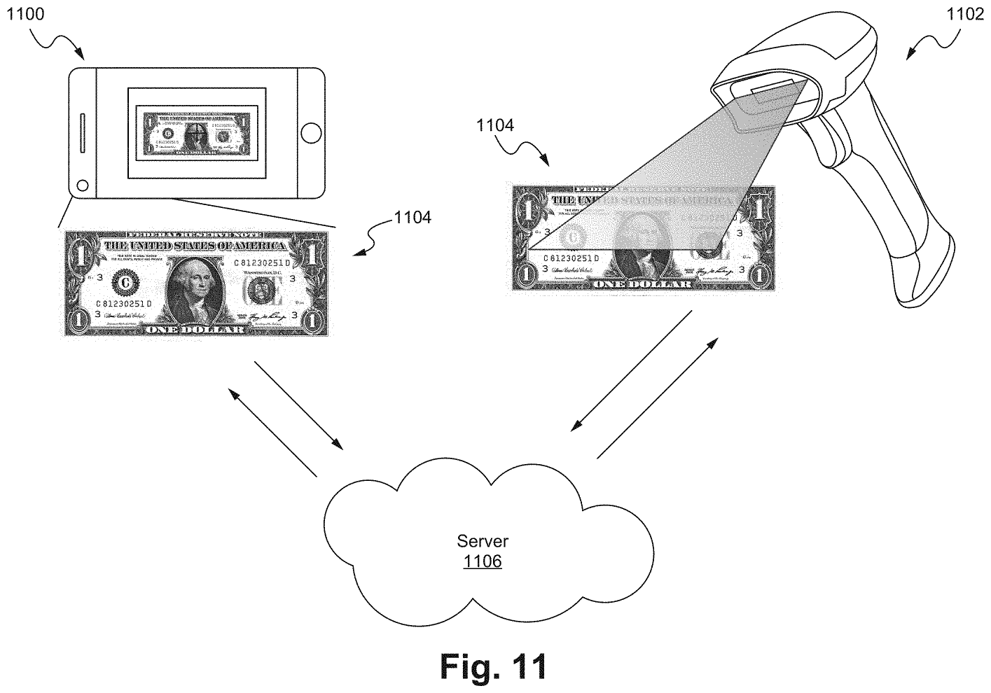

FIG. 10 illustrates a flowchart of a method of implementing a financial management system with physical currency according to some embodiments. In the step 1000, an image of physical currency (e.g., cash) is acquired. The image (or other capture) is acquired by taking a picture of both sides of the cash, scanning the cash to have a scan of the cash, or any other acquisition implementation.

In the step 1002, identifying information from the cash is determined. The identifying information is able to include a serial number or any other information which is unique to each individual bill. Determining the identifying information is able to be performed in any manner such as a mask and image-to-text scanning system. For example, since serial numbers are in the same location on a dollar bill (or any denomination), the remainder of the bill is able to be masked out, so that the image-to-text implementation is able to focus on just the serial number and not get confused with the imagery of the bill. The image-to-text implementation converts the masked image to a text version of the serial number. Any image-to-text implementation is able to be used (e.g., Optical Character Recognition (OCR)). A device (e.g., mobile device, scanner, server) is able to perform fraud detection by detecting a watermark and/or any other anti-counterfeiting measure. The identification information is able to be determined by any device such as a mobile device, a scanner device, or a server device. For example, an app on the mobile device or scanner device includes a feature to perform image processing to determine the serial number of the physical currency. In another example, the server device receives an image of the physical currency, and the server device includes software to process the image to determine the serial number.

In the step 1004, the text version of the serial number or other unique, identifying information is compared with a previously stored unique, identifying information. For example, a serial number of a current bill is compared with a database storing previously acquired serial numbers.

If a match is found, then an indication is made that the bill is not available for use, in the step 1006. For example, an alert is provided to a clerk/cashier receiving the bill that the bill has already been used (e.g., via a photograph/scan), and that the bill is currently worthless. If a match is not found, then the identifying information is stored in a database or other data structure (e.g., a centralized database configured for storing acquired serial numbers), in the step 1008. The transaction is able to occur since the bill is a valid, unused bill. Either party in the transaction is able to store the used bill, and in some embodiments, the bill is able to be taken to the bank for re-authorization of the bill to be used again, where the serial number is removed from the database, and the bill is able to re-enter circulation.

In some embodiments, fewer or additional steps are implemented. In some embodiments, the order of the steps is modified.

FIG. 11 illustrates a diagram of exemplary acquisition devices according to some embodiments. A smart phone/camera 1100 is able to be used to take pictures of physical currency 1104 (e.g., $1, $2, $5, $10, $20, $50, $100 and other physical currency). For example, a user is able to use her smart phone 1100 to take a picture of one or both sides of a dollar bill. The images of the physical currency 1104 are able to be processed by the smart phone 1100, and the unique identification information is compared with unique identification information stored on a secure server device 1106. For example, the unique identification information is able to be sent to the server device 1106 which compares the unique identification information with the stored unique identification information, and if a match is not found, the new unique identification information is stored on the server device 1106. If a match is found, then an alert is sent by the server device 1106 to the smart phone 1100 and/or another device that the dollar bill has already been used. In some embodiments, the smart phone 1100 takes the picture of the physical currency 1104, and sends the picture to the server device 1106 which processes the picture to determine the identification information and performs the data comparison.

A scanner 1102 is able to be used to acquire unique identification information of the physical currency 1104. The scanner 1102 is able to take a picture to acquire the unique identification information. In some embodiments, another implementation is able to be used by the scanner 1102 to acquire the identification information such as a laser scanner. The images of the physical currency 1104 are able to be processed by the smart phone 1100, and the unique identification information is compared with unique identification information stored on a secure server device 1106. For example, the unique identification information is able to be sent to the server device 1106 which compares the unique identification information with the store unique identification information, and if a match is not found, the new unique identification information is stored on the server device 1106. If a match is found, then an alert is sent by the server device 1106 to the scanner 1102 and/or another device that the dollar bill has already been used.

As described herein, the universal card is a payment management, payment processor and financial services provider. The universal card is able to assist in electronic payment management, payment transaction services, transaction risk management, and issues; and processes physical and virtual cards, lines of credit and gift cards, as a domestic and international supplier of electronic payment and risk management services.

The universal card is able to offer products and services in the areas of mobile payments, e-commerce, digitization and finance technology. This includes the integration of payment methods, payment transactions via e-commerce as well as payment transactions at the stationary checkout (POS).

The universal card offers consumers a fully digitalized, mobile payment-app, which works independently of banks or network operators. The app is based on a virtual Visa® or Mastercard® (or other) and runs on mobile devices with the Android or iOS operating systems (or other). The universal card offers contactless payments via a smart phone and tablet through Near Field Communication (NFC) as well as online payments and peer-to-peer transactions.

In the mobile payments sector, the universal card negotiates several contracts with telecommunications providers for technical services with regard to mobile smart phone payments based on NFC.

The payment processor offers its partners a mobile card reader as a white label program for the acceptance of card payments via smart phones or tablets.

All forms of accounts for debits or credits are available for display for any user/consumer within this financial management system: e.g., investment accounts; Social Security accounts; tax (IRS) accounts, checking/savings accounts; EBT accounts, credit card accounts, and others.

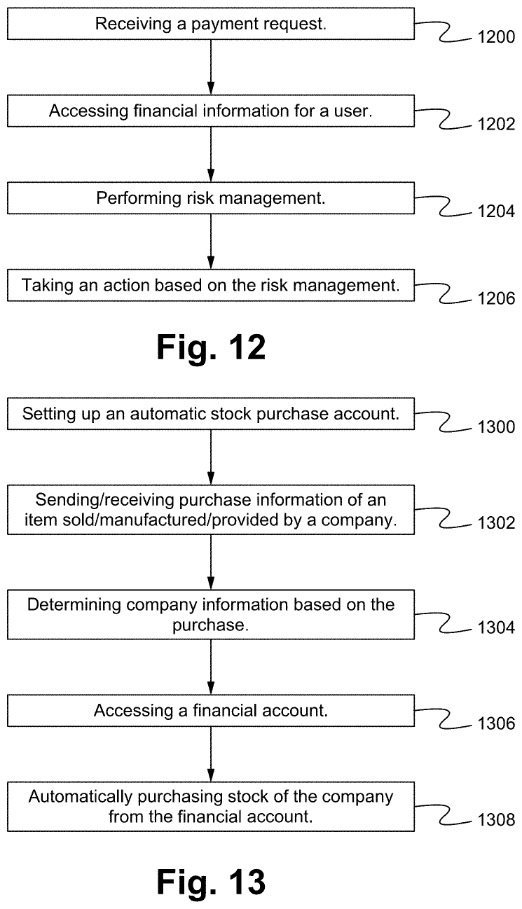

FIG. 12 illustrates a flowchart of a method of implementing a financial management system with risk management according to some embodiments.

In the step 1200, a payment request is received. The payment request is able to be received in any manner such as at a grocery store, where a user is requested to pay for his groceries. The payment request is able to be received at a device (e.g., physical universal card or digitized universal card app on smart phone) from a standard payment processing device (e.g., a credit card reader), an online payment app, a pay station, and/or any other device. For example, the payment request includes: pay $53.25 to Store X. Additional information is able to be included in the payment request such as specific items, the date, the address of the store, and/or other information, in some embodiments. In some embodiments, the items are classified into various groups such as necessities, perks, frivolous/fun, and others. The classifications are able to be used in performing risk analysis as described herein.

In the step 1202, financial information for a user is accessed. As described herein, the universal card/financial management system is able to access all forms of accounts for debits or credits are available for display for any user/consumer within this financial management system: e.g., investment accounts; Social Security accounts; tax (IRS) accounts, checking/savings accounts; EBT accounts, credit card accounts, and others. The universal card/financial management system is also able to access inventory information and any other personal information (e.g., previous purchase history, maintenance history, end of life data).

In the step 1204, risk management is performed with the universal card/financial management system. For example, if a user's debt-to-income ratio is too high (e.g., above a threshold) or other analysis, then the universal card is able to provide an alert or prevent a purchase. In another example, the universal card is able to provide an alternative suggestion such as when a user attempts to purchase a vehicle, the universal card is able to suggest purchasing a less expensive vehicle. Since the universal card is able to access the user's income, savings, expenses and debts, the universal card is able to determine how much a purchase will affect the user financially. For example, the universal card is able to determine that by shopping for clothes at the high-end Store A, the user has little to no savings each month, and by switching to a more reasonable Store Z for clothes, the user is able to have meaningful savings each month. The universal card/management system is also able to keep track of a user's inventory, and as such is able to suggest reducing or eliminating the purchase of a 10^{th} pair of shoes, when the user already has 9 pairs. The universal card/management system is able to make projections in terms of risk management, and if the user has had the same vehicle for 20 years, the universal card is able to suggest saving towards a new car, reducing purchases to save for the new car, or any other planning for the future. In some embodiments, the risk management implementation allows/rejects purchases based on item classification. For example, if a user's debt or debt-to-income ratio is above a threshold, then only necessities are able to be purchased, and all items classified as frivolous are rejected or an alert is triggered. The system is able to alert a user to frivolous items while shopping or at purchase (e.g., by scanning the item bar code with the user's device or a store device).

In the step 1206, an action is taken based on the risk management. For example, if the user's debt-to-income ration would be above a threshold based on the purchase or another limit would be exceeded (e.g., credit card debt above a set amount), then an alert may be triggered and/or the purchase may be rejected or an alternate item may be suggested. If the payment and purchase is able to proceed, the action taken is able to include accessing and determining the source for the payment from the financial information for the payment request from a stored plurality of payment sources. Upon receiving the payment request which is able to include specific information such as the location of the request, the management system determines which source for the payment to be used. As described herein, the management system is able to include a database or data structure for determining which payment source to be used for each purchase location. Determining and accessing the payment source is able to be from a device such as a universal card, a user device (e.g., smart phone) and/or a server. The payment is made using the determined payment source. For example, the selected credit card information is utilized to pay the store, and the transaction is completed. The payment occurs by accessing (via a device) the payment source and receiving payment information from that source. In some embodiments, the order of the steps is modified. In some embodiments, fewer or additional steps are implemented.

The universal card is able to be a fully digitalized, mobile payment-app, which will work independently of banks or network operators. The app is based on a virtual Visa® or Mastercard® (or other) and runs on mobile devices with the Android or iOS operating systems (or other). The universal card offers contactless payments via a smartphone and/or tablet through NFC as well as online payments and peer-to-peer transactions. In the mobile payments sector, the universal card negotiates several contracts with telecommunications providers for technical services with regard to mobile smart phone payments based on NFC.

In some embodiments, when a user purchases a product, stock in the company making/manufacturing or selling the product is automatically purchased. For example, if a user purchases a box of Cheerios®, then a specified amount of money is used to purchase stock shares of General Mills. Partial shares of stock are able to be purchased, or the purchase is delayed until a threshold amount is reached, and then the purchase occurs. The shares are purchased using a bank account or instead of/in addition to a cash-back rewards program for a credit card. The universal card is able to be utilized to purchase the item and/or stock.

FIG. 13 illustrates a flowchart of a method of automatically purchasing stock based on purchases according to some embodiments. In the step 1300, a user sets up an automatic stock purchase account. Setting up the automatic stock purchase account is able to include providing personal information, providing account information, indicating preferences/parameters, setting thresholds, and/or any other configuration information. For example, the user provides credit card information, bank account information and/or stock brokerage information. The bank/brokerage account information enables a system to access the account to purchase stock. In some embodiments, the credit card information is used to purchase stock. In some embodiments, the universal card which has access to the user's accounts provides all of the personal/account information such that the user does not need to re-enter the information.

The user is able to provide any preferences/parameters, such as how much money to invest for each purchase (or what percentage), the threshold for when to purchase stock, what happens if the company of the product is not publicly traded, and/or any other preferences. In some embodiments, setting up the automatic stock purchasing account is performed automatically or semi-automatically. For example, the universal card includes access to a user's credit card information, bank account information, and stock brokerage information.

As described herein, the user is able to set preferences/parameters of stock purchasing. For example, the user is able to limit the number of different companies purchased overall or over a time period. For example, if a user purchases 50 items at a store, and they all happen to be from different publicly traded companies, the user would potentially automatically invest in all 50 companies. However, since the user is able to configure parameters, the user is able to set a limit of companies to invest in for a single day at 5, 10, another number or no limit. Or the user is able to specify a number of overall companies to be invested in. For example, once the user is invested in 20 different companies based on purchases or other factors, purchases of products from other companies do not cause additional stocks to be purchased. Similarly, instead of investing a set amount (e.g., $1 per company per product), a set amount is invested per total purchase to be distributed among the stocks. For example, a user specifies that $10 is to be invested every time the user purchases products from Store X (or any store), and if the user purchases 5 items which are all produced by 5 separate, publicly traded companies, then $2 worth of stock shares are purchased for each company. Furthering the example, if the user then goes to another store an purchases 3 items which are produced by the same public company, then the full $10 is used to purchase shares of that company. In another implementation, the user specifies a target amount to spend (could be a repeating amount or an amount specific to each shopping trip), and the difference between the target amount and the amount spent on products/services is invested. For example, to limit spending but also encourage investing, a user specifies a target of $100 when food shopping. If the user spends $100 or more, then no money is invested. If the user spends less than $100 (e.g., $60), then the difference is invested (e.g., $100 target−$60 spent=$40 for investing). The money would be invested as described herein, in the companies of the products purchased. In some embodiments, the user is able to set a cap or limit on the amount of money invested for a specific time period. For example, the user limits the amount of money automatically invested to $100. In another example, the limit is based on the amount of money remaining in the user's bank account (e.g., do not invest if the bank account balance is below $500).

In the step 1302, the user purchases an item sold/manufactured/provided by a company, and purchase information is sent by a device (e.g., a scanning device, a purchase device, and/or any other device configured for receiving orders/purchases) and received by a server device. For example, a user goes grocery shopping at Store A and purchases 5 items by Company X, 1 item by Company Y, and 2 items by Company Z. The purchases are able to be by any means. For example, a user is able to use a credit card, a universal card as described herein, a mobile device/app, cash/physical currency, and/or any other means.

In the step 1304, company information is determined based on the purchase. During a purchase, a system (e.g., mobile device, server, and/or other device) is able to determine which company manufactures/provides a product. For example, a device/system includes or accesses a database or other data storage of products with links to the manufacturer of each product. In some embodiments, the database includes additional company information such as if there are multiple companies that are part of the manufacturing/distributing process or companies that are upstream or downstream from the manufacturer. The database is also able to include a row, column or other indicator of whether the company is publicly traded. The company information (e.g., stock symbol) for each product purchased and/or other information (e.g., total price of purchase) is able to be communicated to and/or utilized by a device to implement a stock purchase.

In the step 1306, a financial account is accessed. The financial account is able to be accessed by a credit card company, the universal card system, a third party system and/or any other means. The financial account is able to be a banking (e.g., checking/savings) account, a credit account, a brokerage account and/or any other financial account. The financial account is used to provide the funds for automatically purchasing the stock.

For example, if the user uses a credit card, the credit card company is able to receive tracking information of what was purchased to perform the automatic stock purchase. In another example, a universal card is used for the purchase which includes access to the user's source of credit, banking information and/or stock information. In another example, the user is able to use cash while providing account information (e.g., email address, phone number, account number), so that a system is able to apply the purchases to the correct user account.

In the step 1308, stock of the company of the purchased item is purchased. The stock is purchased using the company information which corresponds with the items purchased and the financial information of the user (e.g., bank/stock account information). Continuing with the example from above, since 5 items from Company X were purchased, then $5 is invested in Company X's stock (assuming $1 towards stock per item). Similarly, $1 is invested in Company Y's stock, and $2 is invested in Company Z's stock. Partial shares are able to be purchased if the stock price is greater than the amount to be invested. In some embodiments, if the purchase amount is too low, then the amount to be invested is stored and saved until a threshold is reached, and then a purchase is made. For example, if a user wants to purchase only full shares, and the stock of Company X is $10/share, then the $5 amount is stored, and if the user purchases another 5 items and the stock is still $10/share, then a share is purchased after the second purchase. In some embodiments, instead of using a straight ratio of items to dollars (e.g., 1 item equals $1 to invest), a straight ratio of company to dollars is used (e.g., 5 items from Company X still equals $1 to invest). In another variation, a percentage of the purchase price is invested. For example, a user may purchase one Tesla vehicle for $80,000, so investing $1 for 1 item purchased is not very practical. Rather, the stock purchase equation could be 1% of the purchase price which would be $800 in this example. In some embodiments, more complex equations are able to take into account the user's financial history such as a current amount of money in financial accounts, financial history, projected earnings, age/retirement, investing strategy (e.g., aggressive, conservative), current/historical stock market information, and/or any other relevant data. The stock purchase is able to occur in any manner, using any system/service/server, such as an online brokerage account which is able to search for a company, the company's current stock price, and purchase stock in the company at the stock price.

In some embodiments, fewer or additional steps are implemented. In some embodiments, the order of the steps is modified. For example, instead of the money to invest coming from a user's bank account, the credit card company invests (or provides money to invest) in the company of the product instead of or in addition to cash back rewards or other credit card rewards.

In some embodiments, the stock purchases are for an account other than the user. For example, a user is able to designate a 529 account for the user's child to receive stock purchases based on item purchases by the user.

In some embodiments, when a product is from a company that is not publicly traded, the user is able to designate what happens. For example, the user is able to specify that nothing occurs (e.g., no money is allocated for a stock purchase). In another example, the user is able to specify that an amount of money goes towards the purchase of a cryptocurrency (e.g., bitcoin, ethereum). In another example, stock of a publicly traded competitor of the private company is purchased. Furthering the example, if a user purchases a product produced by Company J (private company), then stock of Company K (public company) is automatically purchased, where Company K is a competitor of Company J, based on the products they sell or other metrics. The user is able to opt-in or opt-out of any of these options.

In some embodiments, risk management as described herein is utilized to determine how much or which stocks to purchase. For example, stock information (e.g., P/E ratio) is able to be analyzed to determine how much money is invested per purchase of a product. For example, a user specifies that if a stock's P/E ratio is at or above a threshold, then only $1 per product or 1% of the purchase price is automatically invested in the stock after the purchase of the product. If the stock's P/E ratio is below the threshold, then $2 per product or 2% of the purchase price is automatically invested in the stock after the purchase of the product. Any number of thresholds are able to be utilized. The thresholds are able to be set by the user or are able to be automatically learned/determined by a machine (e.g., machine learning). For example, machine learning is able to determine an appropriate threshold for a specific stock, since P/E ratios vary based on stock and sector, and a P/E ratio of 15 may be very high for one stock but low for a different stock. The risk management described herein is able to factor in other aspects such as the user's financial information, age, occupation, spending, and/or any other relevant information.

In some embodiments, if a product purchase occurs while stocks are not currently trading (e.g., at night), the automatic stock purchase is able to be delayed until the next day or another time frame. In some embodiments, a user is able to designate a date/time for a stock purchase to occur. For example, the user is paid on the first of each month from her job, so the user configures the system to automatically purchase stock shares on the second day of each month, based on the previous month's purchases.

A server and/or system configured to: receive the purchase information, communicate with a financial account, access the banking information, and/or purchase stock shares, is capable of handling millions of transactions per second, so that the stock look ups and stock share transactions occur seamlessly and without delay.

In some embodiments, instead of or in addition to automatically purchasing stock shares, an interactive implementation is implemented, such that a user is informed of the companies related to the products the user purchases. For example, a chart/text/other graphic is provided to the user via the Web, social media, and/or a direct communication, that 60% of the user's purchases are from Company X, 20% are from Company Y and the rest are from other companies. Based on that information, the user is then able to purchase stock shares of Company X. In some embodiments, the first time the user purchases items using the automatic stock purchase app/system, the user is provided with information via a graphical user interface. For example, the user interface indicates the different companies of the products purchased and whether they are publicly traded (or only shows publicly traded ones), which company produces each purchased product, how much money the user has available to be invested, recommendations for stock purchases, current stock holdings, and/or any other financial/relevant data. In some embodiments, the interactivity only occurs for the first time, first few times (e.g., 3), any number of times, or every time the user makes a purchase which gives the user more control over the stock purchasing.

The pay station described herein is able to be used to automatically purchase stock shares or trigger the purchase of stock shares. For example, when a user inserts or swipes a universal card or credit card, the pay station is able to send data (e.g., product information, purchase price information, user identification information and/or any other information) to a server device which is able to access or communicate with a financial server to purchase stock shares based on the purchased items. The pay station is able to include fraud prevention features described herein such as fingerprint and pulse analysis.

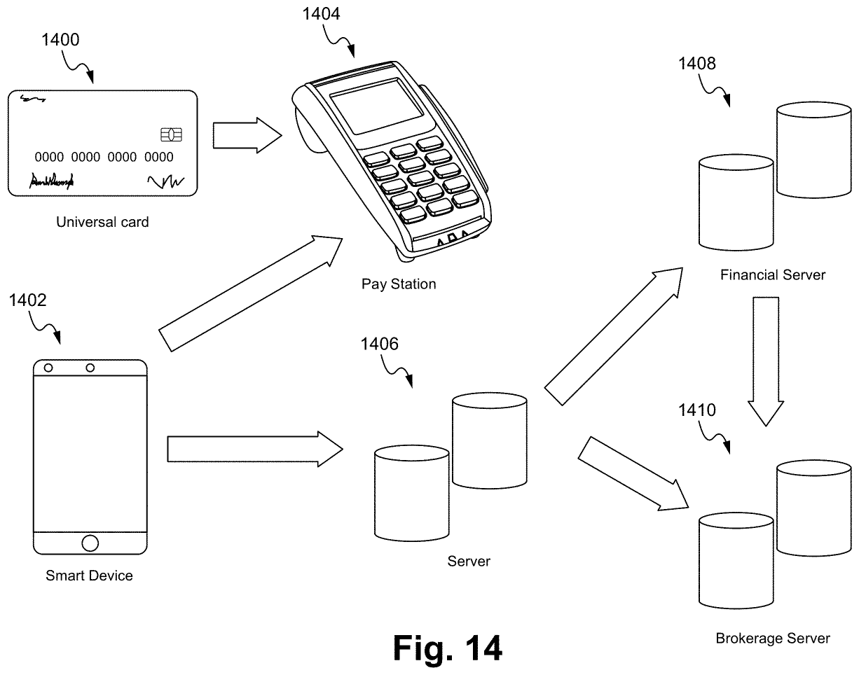

FIG. 14 illustrates a diagram of a system for performing the automatic stock purchasing implementation according to some embodiments. A universal card 1400, a smart device 1402 (e.g., smart phone, smart watch) and/or another device (e.g., credit card) is able to be used to purchase products using a pay station 1404 as described herein. The pay station 1404 includes a scanner to scan the products to be purchased. The pay station 1404 also is able to scan the universal card 1400 or is able to receive an order and purchase information (e.g., via a wireless communication). The pay station 1404 includes additional components such as a pulse scanner, a fingerprint scanner, and/or any other components. The smart device 1402 (or another computing device) is able to be used to purchase a product (e.g., by the user visiting a website or through an app). Although a smart device 1402 is described herein, in some embodiments, any computing device is able to be used to make a purchase (e.g., a personal computer).

The pay station 1404 or smart device 1402 communicates the purchase information to a server 1406. Although a single device is shown as the server 1406, the server 1406 is able to include many devices. For example, a purchasing server is able to communicate the purchase information to the server 1406. The server 1406 receives the purchase information (e.g., product information, price information, user identification information and/or any other relevant information. The server 1406 is able to include data structures to store user information, product information, and/or company/manufacturer information. For example, the server stores a database with user information including corresponding rules regarding investing (e.g., how much or what percentage to invest per purchase) and financial information (e.g., bank account and/or brokerage account information). The server 1406 is also able to store a data structure such as a lookup table which is able to match a company product, SKU code and/or other identification information with a company/manufacture of that product. The server 1406 is able to store other general rules or user-specific rules, such as what to do when a product is sold by a private company. The server 1406 is able to include the financial management system described herein including any risk management and/or any other aspects. In some embodiments, the server 1406 performs the stock share purchase. In some embodiments, the server 1406 communicates with a financial server 1408 (e.g., for access to a user's bank account) and/or a brokerage server 1410 to access money and/or automatically purchase the stock shares. Any of the devices described herein is able to perform the automatic stock purchase. The server 1406 is able to be part of a credit card company, or the server 1406 is able to communicate with a credit card company server, to be able to apply rewards toward the automatic stock share purchase.

In some embodiments, all or most of the processing and analysis is able to occur on a local device (e.g., a user's smart phone). For example, a user is able to scan and pay for products with the smart phone; the smart phone is able to look up the products and the products' sources (e.g., manufacturers); and the smart phone is able to purchase stock shares based on the product/company lookup and using a linked financial account (e.g., bank/stock).

Each step of the process described herein is able to be performed locally, remotely or a combination thereof, at any of the devices described herein.

In some embodiments, the data structure for storing the user information, purchase information and/or company/manufacturer information is optimized to more efficiently store and enable access to data more quickly. For example, the data structure is able to be stored locally on a user's device and in the Cloud (e.g., a server) such that if the Cloud device is inaccessible, the local device is able to perform aspects of the automatic stock purchasing process. Storing the data structure or aspects of the data structure locally is also able to be used to provide faster access to the data, since local storage access times are much shorter than remote storage access times (e.g., accessing data stored on a hard drive is faster than accessing data on a remote server). With data stored locally and remotely, to maintain synchronized data, only delta information is sent to either device. For example, if the data structure on the remote storage is updated, then based on tracking data, only the updated information is provided to the local storage such that both device have the same data.

In some embodiments, multiple, separate data structures (or databases) are used such that multi-threading or other parallel processing techniques are able to be implemented. For example, a first database includes user information such as preferences and bank account information, and a second database includes product information and corresponding company information. The first database is able to be searched at the same time as the second database via multi-threading or pipelining, which enables a much faster lookup of the user's preferences and stock purchase information based on the purchases, to enable a faster purchase of the stock shares. Additionally, since millions of transactions are able to occur at any moment, it is important for the lookup process to be highly efficient.

To utilize the management system, a user inputs financial information such as credit card numbers and bank account information, and/or financial information is able to be retrieved automatically. The management system is able to be implemented with user assistance or automatically without user involvement.

In operation, the management system enables a user to manage the user's finances in a variety of ways including paying for goods and services using a desired line of credit or other account. The management system is also able to be used to provide targeted advertising based on the user's purchases. An autonomous system is able to utilize the management system to provide users with goods and services at appropriate times. The health management system is able to be utilized separately, in conjunction with the financial management system or be incorporated with the financial management system.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
sending purchase information of one or more items, wherein the purchase information includes product information of the one or more items, price information of the one or more items and manufacturer information of the one or more items; and
automatically purchasing stock shares of one or more manufacturers of the one or more items.

2. The method of claim 1 further comprising configuring an automatic stock purchase account.

3. The method of claim 1 further comprising accessing a financial account to automatically purchase the stock shares of the one or more manufactures of the one or more items.

4. The method of claim 3 wherein the financial account comprises a credit card account, and a rewards account is utilized to purchase the stock shares.

5. The method of claim 1 further comprising looking up the manufacturer information stored in a database by cross-checking the product information with the manufacturer information.

6. The method of claim 1 wherein automatically purchasing the stock shares of the one or more manufactures includes allocating a specific amount of money for each purchased item to purchase the stock shares.

7. The method of claim 1 wherein automatically purchasing the stock shares of the one or more manufactures includes utilizing a percentage of the purchase price of the purchased items to purchase the stock shares.

8. The method of claim 1 further comprising automatically investing in a non-stock product when a purchased item is not from a publicly traded company.

9. The method of claim 1 further comprising applying risk management to determine how much money to invest when automatically purchasing the stock shares of the one or more manufacturers.

10. A server device comprising:
a non-transitory memory for storing an application, the application for:
receiving purchase information of one or more items, wherein the purchase information includes price information of the one or more items and manufacturer information of the one or more items; and
automatically purchasing stock shares of one or more manufacturers of the one or more items; and
a processor coupled to the memory, the processor configured for processing the application.

11. The server device of claim 10 wherein the application is further for: configuring an automatic stock purchase account.

12. The server device of claim 10 wherein the application is further for: accessing a financial account to automatically purchase the stock shares of the one or more manufactures of the one or more items.

13. The server device of claim 12 wherein the financial account comprises a credit card account, and a rewards account is utilized to purchase the stock shares.

14. The server device of claim 10 wherein the application is further for: looking up the manufacturer information stored in a database by cross-checking the product information with the manufacturer information.

15. The server device of claim 10 wherein automatically purchasing the stock shares of the one or more manufactures includes allocating a specific amount of money for each purchased item to purchase the stock shares.

16. The server device of claim 10 wherein automatically purchasing the stock shares of the one or more manufactures includes utilizing a percentage of the purchase price of the purchased items to purchase the stock shares.

17. The server device of claim 10 wherein the application is further for automatically investing in a non-stock product when a purchased item is not from a publicly traded company.

18. The server device of claim 10 wherein the application is further for applying risk management to determine how much money to invest when automatically purchasing the stock shares of the one or more manufacturers.

19. An apparatus comprising:
a credit card reader configured for reading a universal payment card;
a smart device receiver configured for receiving information from a smart device;
a biometric reader configured for receiving fingerprint information, retina information, and/or additional biometric information, wherein the biometric reader is further configured for performing life verification which includes using a laser to detect movement of internal structures, detecting reflections of the laser including timing of receiving the reflections, measuring a delta in the reflection times, and if the delta is detected, then it is determined the user is alive;
a non-transitory memory for storing an application, the application for:
sending purchase information of one or more items, wherein the purchase information includes product information of the one or more items, price information of the one or more items and manufacturer information of the one or more items; and
a processor coupled to the memory, the processor configured for processing the application.

20. The apparatus of claim 19 wherein the application is further for: accessing a financial account to automatically purchase the stock shares of the one or more manufactures of the one or more items.

21. The apparatus of claim 20 wherein the financial account comprises a credit card account, and a rewards account is utilized to purchase the stock shares.
